(19) United States
(12) Patent Application Publication
(10) Pub. No.: US 2026/0146490 A1
(43) Pub. Date: May 28, 2026

(54) RECYCLABLE SAFE

(71) Applicant: NCR Atleos Corporation, Atlanta, GA (US)

(72) Inventor: Bruce Dunn, Dundee (GB)

(21) Appl. No.: 19/454,861

(22) Filed: Jan. 21, 2026

Related U.S. Application Data
(63) Continuation of application No. 17/877,031, filed on Jul. 29, 2022, now Pat. No. 12,553,275.

(51) Int. Cl. E05G 1/024

(52) U.S. Cl. CPC E05G 1/024

(57) ABSTRACT

One embodiment is a safe including an outer wall formed of a metal, an inner wall formed of the metal, and a coarse aggregate and fill material filling a gap between the outer and inner walls. The fill material, such as a metal or thermoplastic with a melting point lower than the metal of the inner and outer walls.

### CROSS-REFERENCE TO RELATED APPLICATION

This application is a continuation of U.S. patent application Ser. No. 17/877,031, filed Jul. 29, 2022, which application and publication is incorporated herein by reference in its entirety.

### BACKGROUND INFORMATION

Many modern safes are constructed in layers so that a next layer cannot be defeated in the same manner as previous layer. For example, safes used in many kiosk devices, such as automated teller machines (ATMs) and self-checkout terminals, have inner and outer steel layers with hardened concrete between them. In such safes, tools used to defeat the steel layers are less effective in defeating the concrete layer. However, such safes, from a practical perspective, are non-recyclable as separating the layers is difficult, time consuming, and expensive.

### SUMMARY

Various embodiments herein relate to safes, and in particular, safes that are constructs to maintain security standards while also being capable of disassembly for recycling most if not all materials.

One safe embodiment includes an inner cuboid nested within an outer cuboid. The inner cuboid has at least one face parallel to a face of the outer cuboid. The inner cuboid and outer cuboid formed of a metal, such as mild steel or even stronger steel such as chromoly or tungsten steel alloys. This embodiment further includes an intermediate space between an inner surface of the outer cuboid and an outer surface of the inner cuboid. The intermediate space in such embodiments is filled with a coarse aggregate and a fill material. The fill material fills a remainder of the intermediate space including gaps between the coarse aggregate. The fill material, such as aluminum, tin, or other metal or thermoplastic, has a solid phase at ambient indoor and outdoor temperatures and a melting point lower than the metal forming the inner and outer cuboids. The safe further includes a door on parallel faces of the inner and outer cuboids providing access to an inner cavity of the inner cuboid through the inner and outer cuboids and the filled intermediate space.

Another safe embodiment includes a safe with an outer wall formed of a metal, an inner wall formed of the metal, and a coarse aggregate and fill material filling a gap between the outer and inner walls. The fill material of these embodiments has a solid phase at ambient indoor and outdoor temperatures and a liquid phase at a temperature lower than a melting temperature of the metal forming the inner and outer walls.

A further embodiment in the form of a method includes forming an inner cuboid of a safe from sheet steel having a thickness of at least 2 mm and forming an outer cuboid of a safe from sheet steel having a thickness of at least 2 mm. The method continues by nesting the inner cuboid within the outer cuboid oriented with the inner cuboid having at least one face parallel to a face of the outer cuboid and leaving an intermediate space between an inner surface of the outer cuboid and an outer surface of the inner cuboid. The method may then fill the intermediate space with a coarse aggregate and a fill material that fills a remainder of the intermediate space including gaps between the coarse aggregate. The fill material of such embodiments has a solid phase at ambient indoor and outdoor temperatures and having a melting point lower than the steel forming the inner and outer cuboids. The method also includes providing a door on parallel faces of the inner and outer cuboids providing access an inner cavity of the inner cuboid through the inner and outer cuboids and the filled intermediate space.

### BRIEF DESCRIPTION OF THE DRAWINGS

FIG. 1 is an illustration of a safe, according to an example embodiment.

FIG. 2 is a sectional illustration of a safe according to an example embodiment.

FIG. 3 is a block flow diagram of a method according to an example embodiment.

### DETAILED DESCRIPTION

Various embodiments herein relate to safes, and in particular, safes that are constructed to maintain security standards while also being capable of disassembly for recycling most if not all materials. Such embodiments provide environmentally conscious safes for use in many ways, but as ATMs and self-service checkouts and other currency related kiosk terminals become ubiquitous, the contributions herein go a long way toward minimizing landfill and environmental impact.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

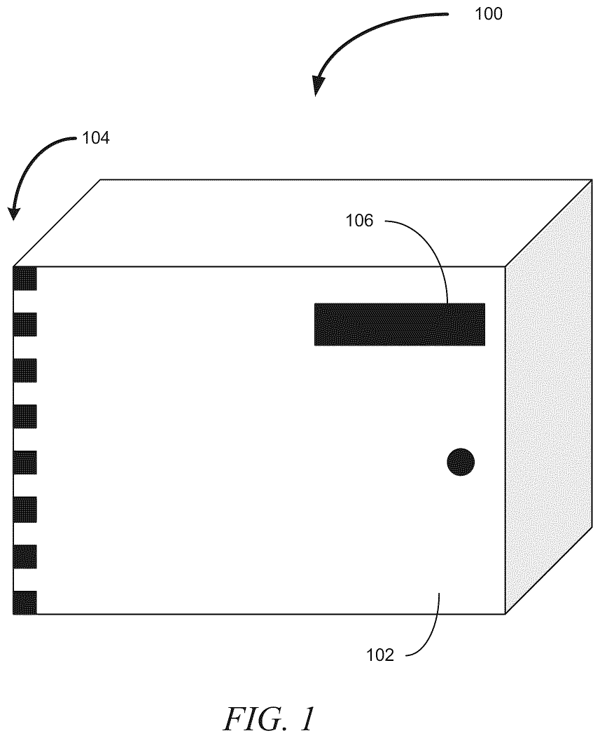

FIG. 1 is an illustration of a safe 100, according to an example embodiment. The safe 100 is generally cuboid in shape, although variation from that shape or rounding of corners is present in various embodiments. The safe 100 may have various dimensions sized according to the needs of a particular deployment. For example, dimensions of the safe 100 may be determined based different factors such as what is to be held in an internal cavity of the safe 100, where the safe 100 is to be deployed or within what the safe is to be installed, a level of security or fireproof requirements that impact safe 100 wall thickness, and other possible factors.

The safe 100, as illustrated includes a hinged 104 door 102 that may be secured by one or more locks. The safe 100, in some embodiments such as in currency related kiosk embodiments, e.g., ATMs, self-service checkouts, includes one or more openings 106 through which currency or other documents may pass to and from an internal cavity of the safe 100. In such embodiments, the internal cavity may be sized to hold one or more currency cartridges and other currency and document handling devices as needed in a particular embodiment.

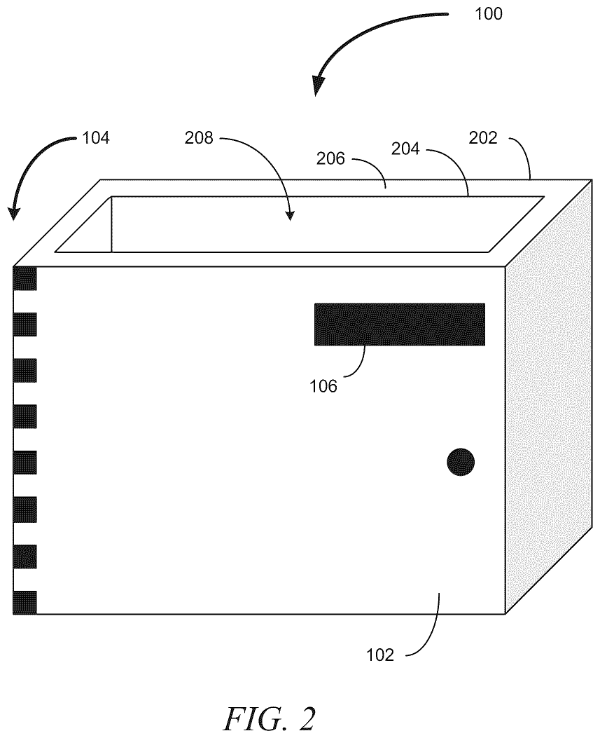

FIG. 2 is a sectional illustration of the safe 100 according to an example embodiment. The safe 100 as illustrated in FIG. 2 has one side removed revealing the internal cavity 208 of the safe 100, the outer and inner walls 202, 204, and the intermediate space 206.

The safe 100 in such embodiments includes the outer wall 202 formed of a metal, the inner 204 wall formed of the metal, and an intermediate space 206 between the outer and inner walls 202, 204. The intermediate space 206 is filled with a coarse aggregate and fill material. The fill material has a solid phase at ambient indoor and outdoor temperatures and a liquid phase at a temperature lower than a melting temperature of the metal forming the inner and outer walls.

For example, the fill material may be aluminum or a thermoplastic such as polycarbonate when the outer and inner walls 202, 204 are made of steel. The lower melting point of the fill material allow for the intermediate space to be filled with the course aggregate and then solidified by pour molten fill material into the intermediate space and allowing it to cool. Conversely, when the safe 100 is to be recycled, the intermediate space 206 of the safe 100 may be exposed through disassembly and then heated until the fill material reaches its liquid phase. The molten fill material may then be poured out or drained, the coarse aggregate separated out, and the outer and inner walls 202, 204 separated. These materials may then be recycled, repurposed, or reused, with little material having to be sent to a landfill.

The safe 100 may be constructed in two or more sections. For example, each wall may be constructed individually. In other embodiments, the portion of the safe 100 illustrated in FIG. 2 may be constructed as one piece and a door or lid may be constructed separately.

In some embodiments, a thickness of the walls of the safe, measured from an outer surface of the outer wall 202 to an inner surface of the inner wall 204 facing the internal cavity 208 is approximately 40 mm. However, the thickness may vary between embodiments and walls of the safe 100 may have differing thicknesses in various embodiments. For example, vertically oriented walls may have one thickness and horizontally oriented walls may have a different thickness.

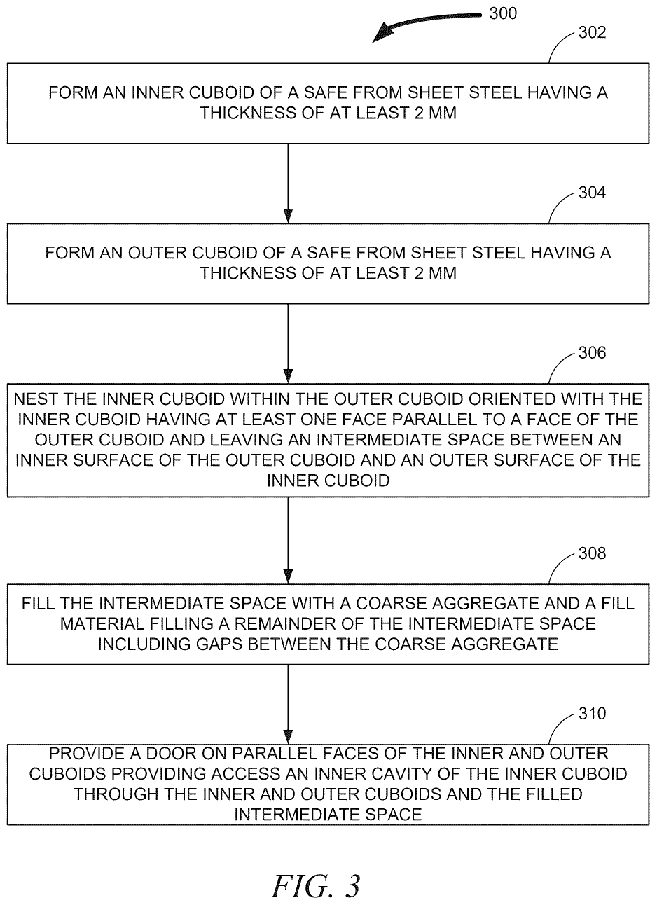

FIG. 3 is a block flow diagram 300 of a method according to an example embodiment. The method 300 is a method that may be performed to construct a safe according to some embodiments.

The method 300 includes forming 302 an inner cuboid of a safe from sheet steel having a thickness of at least 2 mm and forming 304 an outer cuboid of a safe from sheet steel having a thickness of at least 2 mm. The method 300 also includes nesting 306 the inner cuboid within the outer cuboid oriented with the inner cuboid having at least one face parallel to a face of the outer cuboid and leaving an intermediate space between an inner surface of the outer cuboid and an outer surface of the inner cuboid.

The method 300 may continue with filling 308 the intermediate space with a coarse aggregate and a fill material filling a remainder of the intermediate space including gaps between the coarse aggregate. The fill material in some embodiments has a solid phase at ambient indoor and outdoor temperatures and having a melting point lower than the steel forming the inner and outer cuboids. The method 300 additionally includes providing 310 a door on parallel faces of the inner and outer cuboids providing access an inner cavity of the inner cuboid through the inner and outer cuboids and the filled intermediate space.

A safe an additionally embodiment includes an inner cuboid nested within an outer cuboid. The inner cuboid has at least one face parallel to a face of the outer cuboid. The inner cuboid and outer cuboid formed of a metal, such as mild steel or even stronger steel such as chromoly or tungsten steel alloys. This embodiment further includes an intermediate space between an inner surface of the outer cuboid and an outer surface of the inner cuboid. The intermediate space in such embodiments is filled with a coarse aggregate and a fill material. The fill material fills a remainder of the intermediate space including gaps between the coarse aggregate. The fill material, such as aluminum, tin, or other metal or thermoplastic, has a solid phase at ambient indoor and outdoor temperatures and a melting point lower than the metal forming the inner and outer cuboids. The safe further includes a door on parallel faces of the inner and outer cuboids providing access to an inner cavity of the inner cuboid through the inner and outer cuboids and the filled intermediate space.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. (canceled)

2. A method, comprising:
nesting an inner wall within an outer wall to form a safe, the inner wall and the outer wall formed of a metal;
leaving a gap between an inner surface of the outer wall and an outer surface of the inner wall;
filling the gap with a fill material having a melting point lower than a melting point of the metal; and
providing access to an internal cavity of the safe.

3. The method of claim 2, wherein nesting the inner wall within the outer wall includes orienting at least one face of the inner wall parallel to a face of the outer wall.

4. The method of claim 2, wherein filling the gap includes pouring molten fill material into the gap and allowing the molten fill material to cool.

5. The method of claim 2, further comprising heating the fill material to a liquid phase and draining the fill material from the gap.

6. The method of claim 5, further comprising separating the outer wall and the inner wall after draining the fill material.

7. The method of claim 2, wherein filling the gap includes adding a coarse aggregate into the gap prior to adding the fill material.

8. The method of claim 2, further comprising forming passages in the safe sized to allow documents to pass into and out of the internal cavity.

9. The method of claim 2, further comprising sizing the internal cavity to hold currency-related equipment of a kiosk.

10. The method of claim 2, wherein filling the gap includes selecting the fill material from a group consisting of aluminum, tin, and thermoplastic.

11. The method of claim 2, further comprising forming the inner wall and the outer wall in two or more sections that are couplable to form the safe.

12. The method of claim 2, wherein providing access includes installing a hinged door on the safe with one or more locks.

13. A method, comprising:
constructing a wall of a safe from sheet steel; exposing an intermediate space of the safe;
heating the intermediate space until a fill material within the intermediate space reaches a liquid phase, the fill material having a melting point lower than a melting temperature of the sheet steel; draining the fill material from the intermediate space; and
separating materials of the safe for recycling.

14. The method of claim 13, further comprising separating a coarse aggregate from the fill material after draining the fill material.

15. The method of claim 13, wherein exposing the intermediate space includes disassembling two or more sections of the safe.

16. The method of claim 13, further comprising recycling the sheet steel after separating the materials.

17. The method of claim 13, further comprising repurposing the fill material after draining the fill material from the intermediate space.

18. The method of claim 13, wherein heating the intermediate space includes maintaining a temperature lower than the melting temperature of the sheet steel.

19. The method of claim 13, wherein constructing the wall includes forming an inner wall and an outer wall with the intermediate space therebetween.

20. A safe comprising:
an outer wall formed of a metal; an inner wall formed of the metal; and
a fill material filling a gap between the outer wall and the inner wall, the fill material having a liquid phase at a temperature lower than a melting temperature of the metal.

21. The safe of claim 20, further comprising a coarse aggregate within the gap, wherein the fill material fills gaps between the coarse aggregate.
